(19) United States
(12) Patent Application Publication
(10) Pub. No.: US 2024/0211604 A1
(43) Pub. Date: Jun. 27, 2024

(54) BINDING CONFIGURATION STATE TO A BLOCKCHAIN

(71) Applicant: VMware, Inc., Palo Alto, CA (US)

(72) Inventors: Sean James Huntley, Sydney (AU); David Edward Ott, Chandler, AZ (US); Daniel Beveridge, Valrico, FL (US)

(21) Appl. No.: 18/087,959

(22) Filed: Dec. 23, 2022

(51) Int. Cl. G06F 21/57; G06F 8/61

(52) U.S. Cl. CPC G06F 21/577; G06F 8/62; H04L 9/50

(57) ABSTRACT

Disclosed are various embodiments for binding the configuration state of client devices to the blockchain. A management agent can send a request to a smart contract hosted by a blockchain network for a configuration state for the computing device, the request comprising a device identifier for the computing device. The management agent can then receive the configuration state from the smart contract and apply the configuration state to the computing device.

### BACKGROUND

Configurations for client devices are often managed by management services, such as mobile device management (MDM) services, unified endpoint management (UEM) services, etc. These management services can be used to ensure that managed client devices remain in compliance with various rules or compliance policies. For example, a management service could enforce a specific device configuration or application configuration settings in order to ensure compliance. Moreover, updated configuration settings can be provided to client devices as changes to compliance rules or policies are made, and the changes could be enforced by the management service.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a drawing of a network environment according to various embodiments of the present disclosure.

FIG. 3 is a drawing of a network environment according to various embodiments of the present disclosure.

FIG. 4 is a sequence diagram illustrating one example of functionality implemented as portions of an application executed in a computing environment in the network environment of FIG. 1 according to various embodiments of the present disclosure.

FIG. 5 is a sequence diagram illustrating one example of functionality implemented as portions of an application executed in a computing environment in the network environment of FIG. 1 according to various embodiments of the present disclosure.

FIG. 6 is a sequence diagram illustrating one example of functionality implemented as portions of an application executed in a computing environment in the network environment of FIG. 1 according to various embodiments of the present disclosure.

### DETAILED DESCRIPTION

Disclosed are various approaches for binding the configuration state for client devices to an immutable and non-reputable data store, such as a blockchain hosted by a blockchain network. Configuration states for client devices or client applications can be set by an administrator using a management service. The management service can then publish the configuration state to the blockchain. Subsequently, a management agent executing on a client device can query the blockchain to determine whether the client device is compliant with the most recent configuration set by the management service.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

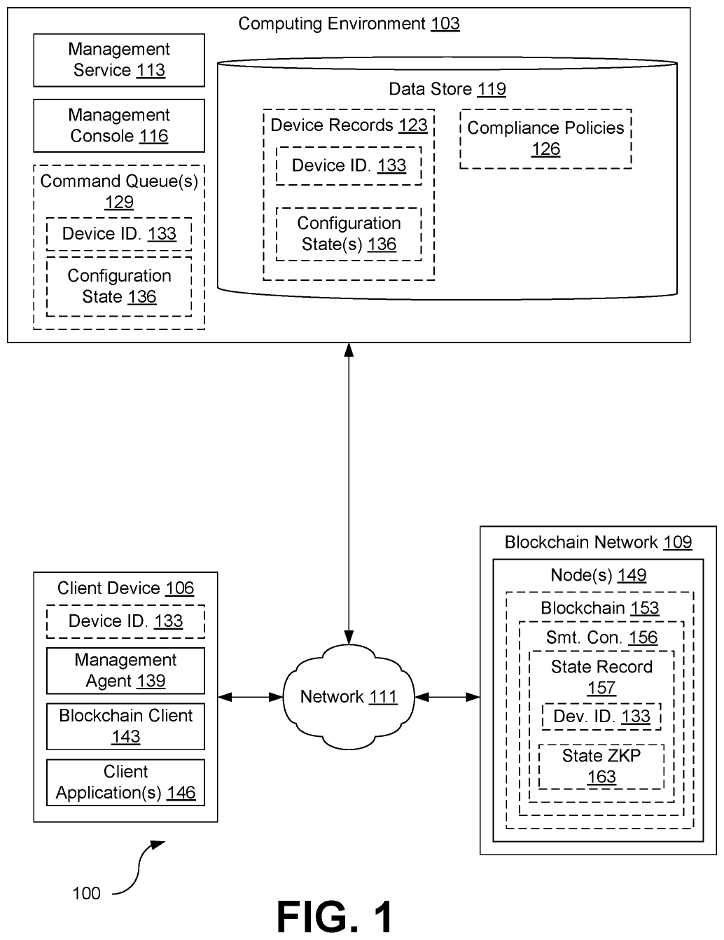

With reference to FIG. 1, shown is a network environment 100 according to various embodiments. The network environment 100 can include a computing environment 103, a client device 106, and a blockchain network 109, which can be in data communication with each other via a network 111. Although depicted separately for illustrative purposes, individual computing devices or software applications within the computing environment 103 could also be members of or participate in the blockchain network 109. Likewise, while depicted separately for illustrative purposes, the client device 106 could also be a member of or participate in the blockchain network 109.

The network 111 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FIR), BLUETOOTH® networks, microwave transmission networks, as well as other networks relying on radio broadcasts. The network 111 can also include a combination of two or more networks 111. Examples of networks 111 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 can include a management service 113, a management console 116, as well as other applications, services, processes, systems, engines, or functionality. Although the management service 113 and the management console 116 are depicted separately for illustrative purposes, some or all of these applications could be combined into a single application that implements the functionality of the combined applications. Moreover, one or more of these applications could be executed on the same computing device within the computing environment 103 or on one or more separate computing devices within the computing environment 103.

Also, various data is stored in a data store 119 that is accessible to the computing environment 103. The data store 119 can be representative of a plurality of data stores 119, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 119 is associated with the operation of the various applications or functional entities described below. This data can include one or more device records 123, one or more compliance policies 126, as well as potentially other data.

In addition to the data stored in the data store 119, the computing environment 103 could also maintain one or more command queues 129. In some implementations, the command queues 129 could be maintained or stored in a separate data structure or location, as illustrated. In other implementations, however, the command queues 129 could be stored in the data store 119 along with the device records 123 and the compliance policies 126.

A device record 123 can be used to store any information related to a client device 106 enrolled with or managed by the management service 113. This can include any information about the current or last known state of the client device 106, such as applications installed on the client device or the last reported state of the client device 106. This can also include information about the user who is currently using the client device 106. Accordingly, the device record 123 can include information such as a device identifier 133, and one or more configuration states 136.

The device identifier 133 can include any identifier that uniquely identifies one client device 106 with respect to another client device 106. Examples of device identifiers 133 include device names, globally unique identifiers (GUIDs), universally unique identifiers (UUIDs), network interface media access controller (MAC) addresses, international mobile equipment identity (IMEI) numbers, etc.

A configuration state 136 can represent any current or past configuration of the client device 106. The configuration state 136 can include values to be used for operating system settings for the client device 106 or for settings for individual applications installed on the client device 106. Text or markup language files (e.g., extensible markup language (XML) or yet another markup language (YAML) files) could be used to store a configuration state 136. The current configuration state 136 can be stored in a command queue 129 in order to be retrieved by the client device 106. The management service 113 can also publish the current configuration state 136 to the blockchain network 109 for reference by client devices 106.

A compliance policy 126 can represent one or more policies that must be satisfied by client device 106 when applied to the client device 106. Compliance policies 126 can specify a range of configuration settings or options that the current configuration state 136 of the client device 106 must satisfy in order to be considered compliant. For example, a compliance policy 126 could specify that certain applications are required to be installed on the client device 106 or are prohibited from being installed on the client device 106. As another example, a compliance policy 126 could specify a minimum version of an application installed on the client device 106 or minimum operating system version for the client device 106. Similarly, a compliance policy 126 could specify prohibited versions of applications, such as versions that contain a known or unpatched security vulnerability. A compliance policy 126 could also specify permitted or prohibited network connections, domain name system (DNS) servers, virtual private network (VPN) configurations or settings, etc. Although these examples are illustrative of the types of compliance policies 126 that could be deployed, other mandatory configuration settings could be specified by one or more compliance policies 126.

The management service 113 can be executed to manage the configuration of registered or enrolled client devices 106. This can include evaluating individual compliance policies 126 to determine an appropriate configuration state 136 for a client device 106 and distributing the configuration state 136 to client devices 106. The management service 113 can also provide various facilities or mechanisms to determine or otherwise ensure that enrolled client devices 106 are compliant with the applicable compliance policies 126.

The management console 116 can represent any user interface or user front-end to the management service 113. In some implementations, the management console 116 could be executed as a separate, independent service that interacts with the management service 113. In other implementations, the management console 116 could be a component of the management service 113. The management console 116 can represent any user interface or user front-end that allows an administrator or other user to manage, review, or analyze client devices 106 that are enrolled with the management service 113. The management console 116 could be accessible using a client device 106 over the network 111.

The client device 106 is representative of a plurality of client devices that can be coupled to the network 111. This could include physical devices embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. This could also include virtual or logical devices, such as virtual machines, containers, etc. The client device 106 can be configured to execute various applications such as a management agent 139, a blockchain client 143, and one or more client applications 146.

The management agent 139 to locally manage the client device 106 in order to enforce configuration settings specified by the management service 116 in the configuration state 136. The management agent 139 can be installed with elevated privileges or be effectuated through operating system APIs to manage the client device 106 on behalf of the management service 113. The management agent 139 can have the authority to manage data on the client device 106, install, remove, or disable certain applications, or install configuration profiles, such as VPN certificates, Wi-Fi profiles, email profiles, etc. The management agent 139 can also have the authority to enable or disable certain hardware features of the client device 106 that as specified in the configuration state 136 for the client device 106. The management agent 139 can also place the device into different hardware modes, such as airplane mode, silent mode, do-not-disturb mode, or other modes supported by the client device 106.

The blockchain client 143 can represent any type of software application or library that allows for the client device 106 to connect and interact with the blockchain network 109. Examples of blockchain clients 143 include full blockchain nodes 149, light blockchain clients, and stateless blockchain clients. In some implementations, the blockchain client 143 and the management agent 139 may be tightly coupled, whereby the management agent 139 is required to use the blockchain client 143 to perform various operations. In some of these implementations, the management agent 139 and the blockchain client 143 could be deployed as a single instance of an application.

The blockchain network 109 represents a peer-to-peer network of nodes 149 that utilizes a consensus protocol to maintain an immutable, append only, eventually consistent data store such as a blockchain 153. In some implementations, the blockchain network 109 could be a permissioned blockchain network 109, where only authorized nodes 149 are permitted to join or participate in the blockchain network 109. Examples of permissioned blockchain networks include HYPERLEDGER FABRIC, QUOROM, CORDA, or VMWARE BLOCKCHAIN. In other implementations, the blockchain network 109 could be permissionless, where anyone is permitted to join the blockchain network 109. Examples of public or permissionless blockchain networks 109 include the BITCOIN network, the ETHEREUM network, the SOLANA network, etc.

Nodes 149 of the blockchain network 109 can represent computing devices and/or virtual machines that maintain a copy of the blockchain 153 and all transactions submitted to the blockchain network 109 for inclusion in the blockchain 153. In some blockchain networks 109, individual nodes 149 can perform specialized functions, such as creating or validating new blocks for the blockchain 153 (sometimes referred to as “mining”), storing a copy of the current state of the blockchain 153, responding to requests for the current state of the blockchain 153, etc. In other blockchain networks 109, one or more of these functions to be performed by the same node 149.

The blockchain 153 can represent an immutable, append only, eventually consistent distributed data store maintained by a plurality of nodes 149 in a peer-to-peer network that maintain duplicate copies of data stored in the blockchain 153. The nodes 149 of the blockchain network 109 can use a variety of consensus protocols to coordinate the writing of data written to the blockchain 153. In order to store data to the blockchain 153, such as a record of a transaction of cryptocurrency coins or tokens between wallet addresses, users can pay cryptocurrency coins or tokens to one or more of the nodes 149 of the blockchain 153.

New data is written to the blockchain 153 in the form of blocks, with each block including the cryptographic hash of the previous block in the blockchain 153, thereby preventing tampering or altering of records stored in the blockchain 153. For example, whenever a new configuration state 136 is saved to a device record 123 by the management service 113, the management service 113 could save the new configuration state 136 to a new block in the blockchain 153. The management service 113 could also store the device identifier 133 of each client device 106 that the new configuration state 136 is applicable to. In some implementations, a cryptographic hash or other zero-knowledge proof of the configuration state 136 could be saved to the blockchain 153.

In some implementations, a smart contract 156 can be hosted on the blockchain 153. A smart contract can represent executable computer code that can be executed by a node 149 of the blockchain network 109. In many implementations, the smart contract 156 can expose one or more functions that can be called by any user or by a limited set of users. To execute one or more functions of a smart contract 156, an application can submit a request to a node 149 of the blockchain network 109 to execute the function. The node 149 can then execute the function and store the result to the blockchain 153. Nodes 149 may charge fees in the form of cryptocurrency coins or tokens to execute a function and store the output, with more complicated or extensive functions requiring larger fees. An example of this implementation is the ETHEREUM blockchain network, where users can pay fees, referred to as “gas,” in order to have a node of the ETHEREUM blockchain network execute the function and store the result to the ETHEREUM blockchain. Additionally, the more “gas” a user pays, the more quickly the function will be executed, and its results committed to the ETHEREUM blockchain.

The smart contract 156 can be used to store and maintain data on the blockchain related to the operation of the management service 113 and the management agent 139. For example, the smart contract 156 could maintain one or more state records 157, which could be stored on the blockchain 153. Each state record 157 could represent the current configuration state 136 for a client device 106 to remain in compliance with the compliance policies 126. However, because the blockchain 153 may be publicly accessible, it could be undesirable to store the current configuration state 136 itself on the blockchain 153. Accordingly, a state record 157 could include a device identifier 133 for a specific client device 106 and a state zero-knowledge proof (ZKP) 163 that represents an attestation of the current state of the client device 106. The management agent 139 could generate the state ZKP 163 and submit it to the smart contract 156 to store on the blockchain 153 to prove that the current state of the client device 106 complies with the current configuration state 136 assigned by the management service 113 without explicitly disclosing the current configuration of the client device 106. The management service 113 or other applications (e.g., such as those run by auditors) could evaluate the state ZKP 163 to confirm that state the client device 106 matches the configuration state 136 specified for the client device 106. Examples of ZKPs that could be used for the state ZKP 163 can include non-interactive zero knowledge (NIZK) proofs, zero-knowledge succinct non-interactive argument of knowledge (zk-SNARK) proofs, zero-knowledge scalable transparent argument of knowledge (zk-STARK) proofs, or similar attestations.

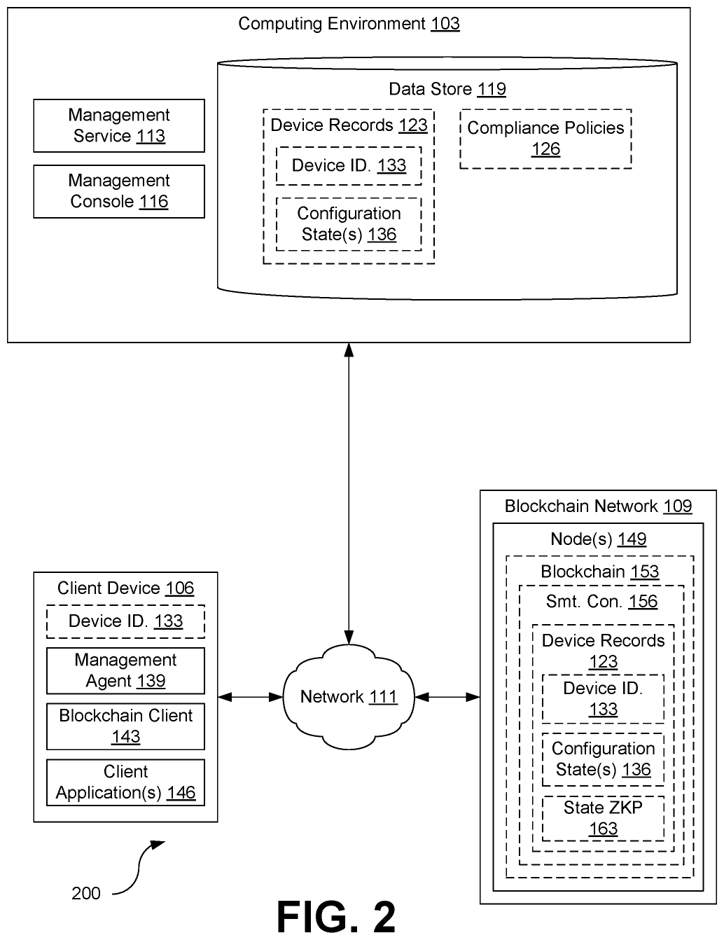

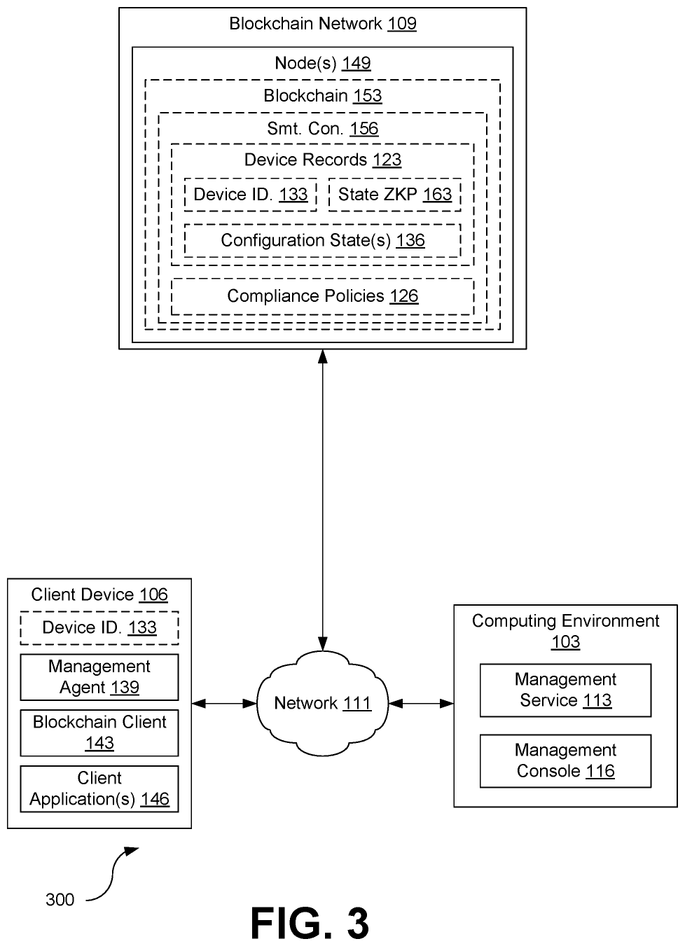

Next, a general description of the operation of the various components of the network environment 100 is provided. Although the following description provides an example of the operation of the network environment 100, other interactions between the various components of the network environment 100 are also included within the scope of the various embodiments of the present disclosure. More detailed descriptions of the operations of specific components of the network environment 100 are provided in the discussion accompanying FIGS. 2 and 3.

To begin, the management service 113 can enroll one or more client devices 106 for mobile device management or unified endpoint management (UEM) services. Accordingly, the management service 113 can identify and authenticate one of the client devices 106 and store data related to the client device 106 in a device record 123 for later reference. In some cases, the management service 113 can also be registered as a device administrator of the client device 106, permitting the management service 113 to configure and manage certain operating aspects of the client device 106.

Once a client device 106 is enrolled for device management by the management service 113, the management service 113 can create an individual command queue 129 for the client device 106 and/or assign the client device 106 to one or more group command queues 129. An individual command queue 129 could be maintained for client device 106 specific commands or configurations. Group command queues 129 could be maintained for commands or configurations that are applicable to groups of client devices 106 (e.g., all client devices 106 within an organization or department, all client devices 106 of a particular type, etc.).

The management service 113 can also determine which compliance policies 126 are applicable to the enrolled or registered client device 106 and create an appropriate configuration state 136 for the client device 106. For example, the management service 113 could evaluate any groups or rolls that the client device 106 has been assigned to, and then select any compliance policies 126 assigned to those groups or roles. Moreover, the management service 113 could evaluate any compliance policies 126 that were assigned to the client device 106 specifically (e.g., because an administrator using the management console 116 assigned the compliance policies 126 to the client device 106). As a result of the evaluation, the management service 113 could generate a configuration state 136 for the client device 106 and save the configuration state 136 to the appropriate device record 123.

The management service 113 can then distribute the configuration state 136 to the client device 106. For example, the management service 113 could save the configuration state 136 to the appropriate command queue 129 for the client device 106. The management service 113 could also create and save a copy of the new configuration state 136 associated with the device identifier 133 of the device record 123 of the client device 106 to a new block 156 in the blockchain 153. In some instances, the configuration state 136 itself could be saved, while in other instances, a zero-knowledge proof of the configuration state 136 could be saved to the block 156 of the blockchain 153.

Meanwhile, the management agent 139 executing on the client device 106 can periodically evaluate the current state of the client device 106 to determine if is compliant with one or more compliance policies 126 or if its configuration state 136 is the current configuration state 136 published by the management service 113. For example, the management agent 139 could use the blockchain client 143 to obtain the latest version of the configuration state 136 published to the blockchain 153 by the management service 113. If the current state of the client device 106 fails to match the latest configuration state 136 stored on the blockchain 153, then the management agent 139 could retrieve the configuration state 136 from the command queue 129 provided by the management service 113. The management agent 139 could then apply the configuration state 136 retrieved from the command queue 129 to the client device 106. In some implementations, the management agent 139 could then publish to the blockchain 153 an acknowledgement of its current configuration state 136 as proof that the client device 106 is currently in a compliant state.

FIG. 2 depicts a network environment 200 according to various embodiments. The network environment 200 can include a computing environment 103, a client device 106, and a blockchain network 109, which can be in data communication with each other via a network 111. Although depicted separately for illustrative purposes, individual computing devices or software applications within the computing environment 103 could also be members of or participate in the blockchain network 109. Likewise, while depicted separately for illustrative purposes, the client device 106 could also be a member of or participate in the blockchain network 109.

The network environment 200 has many of the same components as the network environment 100. For example, the computing environment 103 can execute a management service 113 and a management console 116, as previously described. Moreover, the computing environment 103 can host a data store 119, which can store one or more device records 123 and one or more compliance policies 126. Likewise, each client device 106 can store a device identifier 133 and can also host or otherwise execute a management agent 139, blockchain client 143, and/or one or more client applications 146. Likewise, the blockchain network 109 can be formed from one or more nodes 149 that host a blockchain 153. The blockchain 153 can store various data or executable programs, such as the smart contract 156. Unlike the network environment 100 of FIG. 1, the smart contract 156 of the blockchain 153 can store one or more of the device records 123, which can include the device identifier 133 for each device record 123 as well as one or more configuration states 136.

In implementations such as those depicted in the network environment 200 of FIG. 2, the configuration state 136 of a client device 106 is tightly coupled to the blockchain 153, providing for verifiability, auditability, and nonrepudiation. The management service 113 can create and store device records 123 on the blockchain 153 by interacting with the smart contract 156. When a new configuration state 136 is created for a device record 123 (e.g., because the client device 106 is to become compliant with an additional, new, or modified compliance policy 126), the new configuration state 136 can be saved to the appropriate device record 123 in the data store 119. Subsequently, the management service 113 can publish the new configuration state 136 to the blockchain by interacting with the smart contract 156. The blockchain client 143 can later retrieve the current or latest configuration state 136 from the device record 123 stored by the smart contract 156, and the configuration state 136 can be applied to the client device 106 by the management agent 139.

FIG. 3 depicts a network environment 300 according to various embodiments. The network environment 300 can include a computing environment 103, a client device 106, and a blockchain network 109, which can be in data communication with each other via a network 111. Although depicted separately for illustrative purposes, individual computing devices or software applications within the computing environment 103 could also be members of or participate in the blockchain network 109. Likewise, while depicted separately for illustrative purposes, the client device 106 could also be a member of or participate in the blockchain network 109.

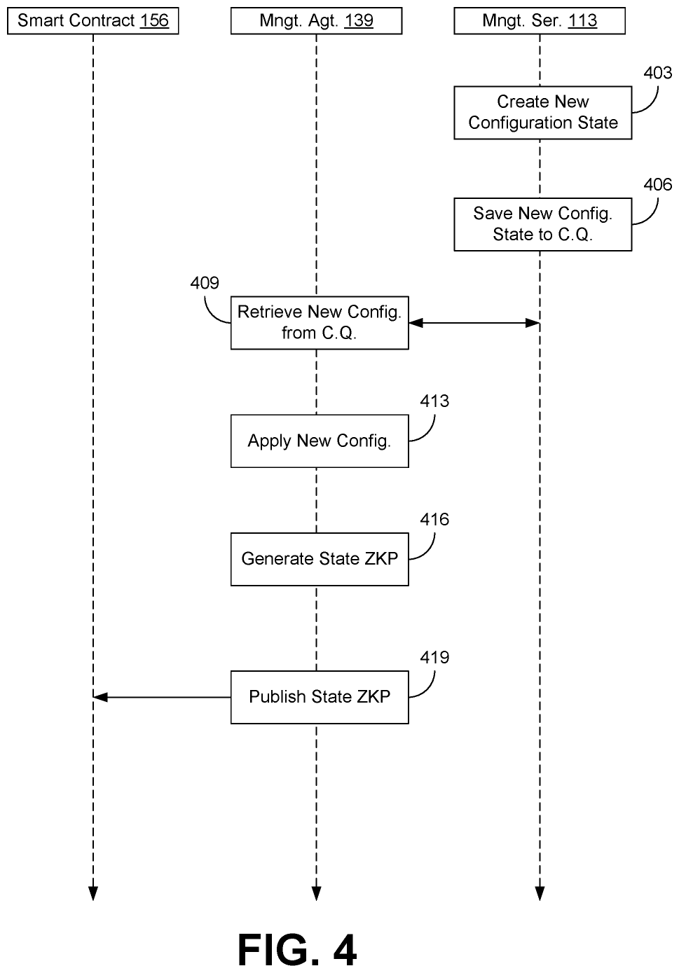

The network environment 300 has many of the same components as the network environment 100. For example, the computing environment 103 can execute a management service 113 and a management console 116, as previously described. Likewise, each client device 106 can store a device identifier 133 and can also host or otherwise execute a management agent 139, blockchain client 143, and/or one or more client applications 146. Likewise, the blockchain network 109 can be formed from one or more nodes 149 that host a blockchain 153. The blockchain 153 can store various data or executable programs, such as the smart contract 156. Unlike the network environment 100 of FIG. 1 or the network environment 200 of FIG. 4, the smart contract 156 of the blockchain 153 can store one or more of the device records 123 and one or more compliance policies 126. The device records 123 stored by the smart contract 156 on the blockchain 153 can include the device identifier 133 for each device record 123 as well as one or more configuration states 136.

In implementations such as those depicted in the network environment 300 of FIG. 3, the configuration state 136 of a client device 106 and the compliance policies 126 to be enforced are tightly coupled to the blockchain 153, providing for verifiability, auditability, and nonrepudiation. The management service 113 can create and store device records 123 and compliance policies 126 on the blockchain 153 by interacting with the smart contract 156. When a new configuration state 136 is created for a device record 123 (e.g., because the client device 106 is to become compliant with an additional, new, or modified compliance policy 126), the new configuration state 136 can be saved to the appropriate device record 123 in the data store 119. Subsequently, the management service 113 can publish the new configuration state 136 to the blockchain by interacting with the smart contract 156. The blockchain client 143 can later retrieve the current or latest configuration state 136 from the device record 123 stored by the smart contract 156, and the configuration state 136 can be applied to the client device 106 by the management agent 139.

Referring next to FIG. 4, shown is a sequence diagram that provides one example of the interactions between the management service 113, the management agent 139, and the smart contract 156 in the network environment 100 of FIG. 1. The sequence diagram of FIG. 4 provides merely an example of the many different types of functional arrangements that can be employed to implement the operations of the depicted portions of the management service 113, the management agent 139, and the smart contract 156. As an alternative, the sequence diagram of FIG. 4 can be viewed as depicting an example of elements of a method implemented within the network environment 100.

Beginning with block 403, the management service 113 can create a new configuration state 136 for a client device 106. This could happen in response to a number of events. For example, when a client device 106 is first registered or enrolled with the management service 113, the management service 113 could create an initial configuration state 136 for the client device 106 based at least in part on the applicable compliance policies 136. As another example, when changes to the compliance policies 126 are made, an updated configuration state 136 could be created by the management service 113. Examples of changes to the compliance polices 126 can include the creation or removal of compliance policies 126 or the modification of an existing compliance policy 126. Once the new configuration state 136 is created for the client device 106, it can be stored in the device record 123 of the client device 106.

Meanwhile, at block 406, the management service 113 can save the new configuration state 136 to the appropriate command queue 129 for the client device 106. For example, the management service 113 could search for a command queue 129 with a matching device identifier 133. The management service 113 could then add the configuration state 136 to the command queue 129.

At block 409, the management agent 139 can connect to the management service 113 to retrieve the current or most recent configuration state 136 from the command queue 129. For example, the management agent 139 could send a request that includes the device identifier 133 of the client device 106. The management service 113 could then search for a matching command queue 129 and return the configuration state 136 stored in the command queue 129 assigned to the client device 106. The management service 113 could then remove the configuration state 136 from the command queue 129.

Next, at block 413, the management agent 139 can apply the new configuration state 136 retrieve from the command queue 129 to the client device 106. For example, the management agent 139 could install or uninstall client applications 146 specified by the configuration state 136. This could be done by determining whether a client application 146 that is listed in the configuration state 136 is installed on the client device 106. If the client application 146 is not installed on the client device 106, but should be per the configuration state 136, then the management agent 139 could cause the client application 146 to be installed (e.g., by downloading and installing the application from an application store or from an installer located in a predefined application repository or library). Similarly, if the client application is installed on the client device 106, but should not be installed per the configuration state 136, then the management agent 139 could cause the client application 146 to be uninstalled. Similarly, the management agent 146 could update application or operating system settings specified in the configuration state 136 to new values specified in configuration state 136.

Subsequently, at block 416, the management agent 139 can generate a state ZKP 163 after updating the client device 106 to be consistent with the configuration specified by the configuration state 136 retrieved from the command queue 129. Various different types of zero knowledge proofs can be used depending on the desires for a particular implementation, such as non-interactive zero knowledge (NIZK) proofs, zero-knowledge succinct non-interactive argument of knowledge (zk-SNARK) proofs, and zero-knowledge scalable transparent argument of knowledge (zk-STARK) proofs.

Finally, at block 419, the management agent 139 could publish the state ZKP 163 to the blockchain 153 as a confirmation that the configuration state 136 has been applied to the client device 106. For example, the management agent 139 could invoke a function provided by the smart contract 153 and provide the device identifier 133 of the client device 106 and the state ZKP 163 as arguments to the function. The smart contract 153 could then identify the state record 157 with the matching device identifier 133 and store the state ZKP 163 in the state record 157 (e.g., by replacing the previously stored state ZKP 163).

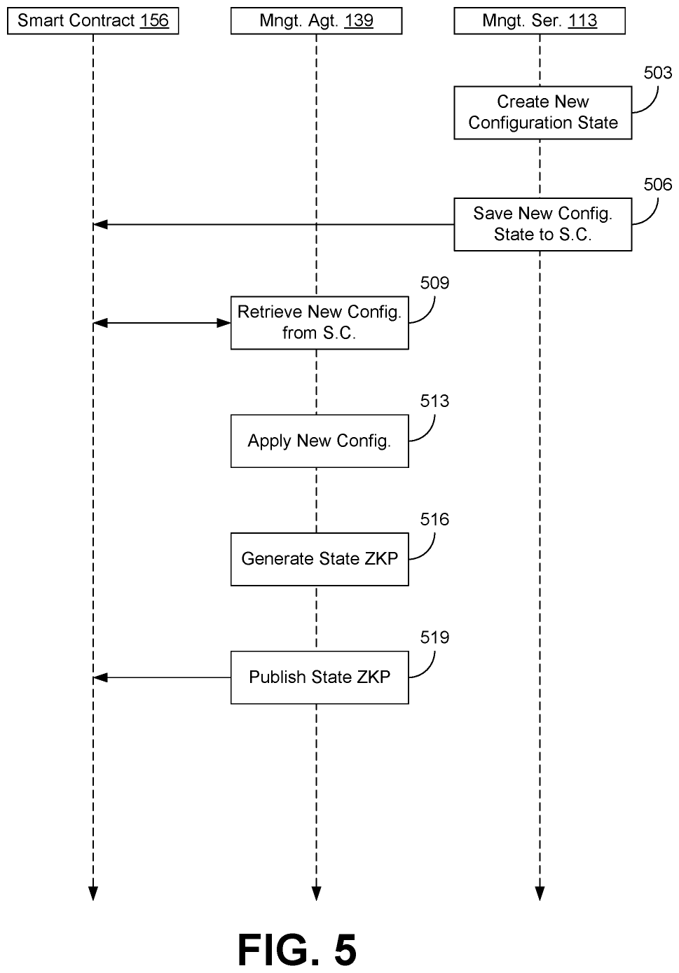

Referring next to FIG. 5, shown is a sequence diagram that provides one example of the interactions between the management service 113, the management agent 139, and the smart contract 156 in the network environment 200 of FIG. 2 or the network environment 300 of FIG. 3. The sequence diagram of FIG. 5 provides merely an example of the many different types of functional arrangements that can be employed to implement the operations of the depicted portions of the management service 113, the management agent 139, and the smart contract 156. As an alternative, the sequence diagram of FIG. 5 can be viewed as depicting an example of elements of a method implemented within the network environment 200 or the network environment 300 of FIG. 3.

Beginning with block 503, the management service 113 can create a new configuration state 136 for a client device 106. This could happen in response to a number of events. For example, when a client device 106 is first registered or enrolled with the management service 113, the management service 113 could create an initial configuration state 136 for the client device 106 based at least in part on the applicable compliance policies 136. As another example, when changes to the compliance policies 126 are made, an updated configuration state 136 could be created by the management service 113. Examples of changes to the compliance polices 126 can include the creation or removal of compliance policies 126 or the modification of an existing compliance policy 126. Once the new configuration state 136 is created for the client device 106, it can be stored in the device record 123 of the client device 106.

Meanwhile, at block 506, the management service 113 can save the new configuration state 136 to the device record 123 for the client device 106 maintained by the smart contract 156. For example, the management service 113 could call a function of the smart contract 156 with the device identifier 133 and the configuration state 136 provided as arguments or parameters to the function. The smart contract 156 could then update or modify the device record 123 to include the new configuration state 136.

At block 509, the management agent 139 can retrieve the current or most recent configuration state 136 from the blockchain network 109. For example, the management agent 139 call a function of the smart contract 156 with the device identifier 133 of the client device 106 as argument or parameter to the function. The smart contract 156 could then return the configuration state 136 stored in the device record 123 with the matching device identifier 133 provided as an argument.

Next, at block 513, the management agent 139 can apply the new configuration state 136 retrieve from the command queue 129 to the client device 106. For example, the management agent 139 could install or uninstall client applications 146 specified by the configuration state 136. This could be done by determining whether a client application 146 that is listed in the configuration state 136 is installed on the client device 106. If the client application 146 is not installed on the client device 106, but should be per the configuration state 136, then the management agent 139 could cause the client application 146 to be installed (e.g., by downloading and installing the application from an application store or from an installer located in a predefined application repository or library). Similarly, if the client application is installed on the client device 106, but should not be installed per the configuration state 136, then the management agent 139 could cause the client application 146 to be uninstalled. Similarly, the management agent 146 could update application or operating system settings specified in the configuration state 136 to new values specified in configuration state 136.

Subsequently, at block 516, the management agent 139 can generate a state ZKP 163 after updating the client device 106 to be consistent with the configuration specified by the configuration state 136 retrieved from the command queue 129. Various different types of zero knowledge proofs can be used depending on the desires for a particular implementation, such as non-interactive zero knowledge (NIZK) proofs, zero-knowledge succinct non-interactive argument of knowledge (zk-SNARK) proofs, and zero-knowledge scalable transparent argument of knowledge (zk-STARK) proofs.

Finally, at block 519, the management agent 139 could publish the state ZKP 163 to the blockchain 153 as a confirmation that the configuration state 136 has been applied to the client device 106. For example, the management agent 139 could invoke a function provided by the smart contract 153 and provide the device identifier 133 of the client device 106 and the state ZKP 163 as arguments to the function. The smart contract 153 could then identify the state record 157 with the matching device identifier 133 and store the state ZKP 163 in the state record 157 (e.g., by replacing the previously stored state ZKP 163).

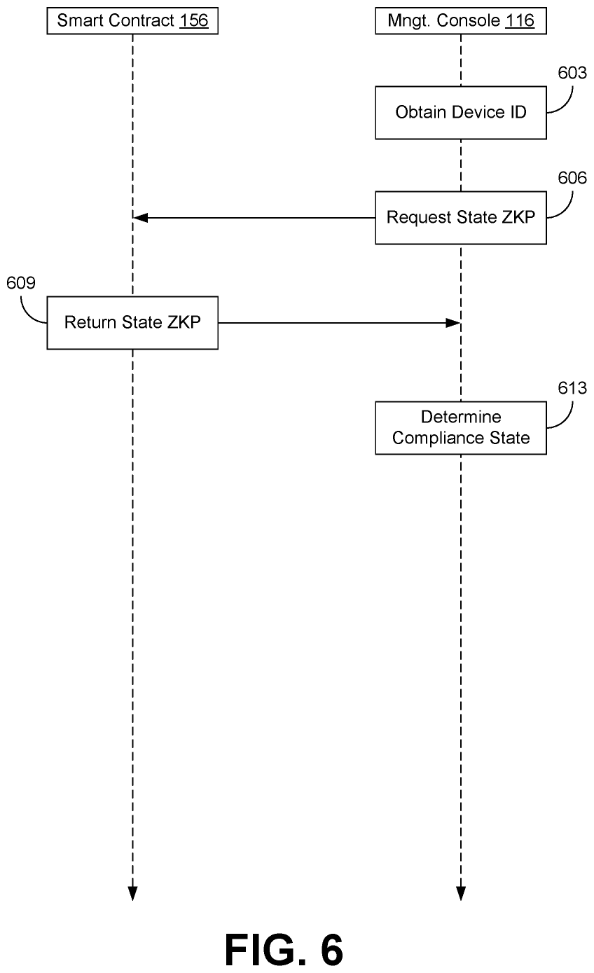

Referring next to FIG. 6, shown is a sequence diagram that provides one example of how the compliance of a client device 106 with the compliance policies 126 could be audited or confirmed in any of the network environments 100, 200, or 300 depicted in FIG. 1, 2, or 3. Although the interactions are depicted between the management console 116 and the smart contract 156, other applications or services could interact with the smart contract 153 for similar purposes and to similar effect. The sequence diagram of FIG. 6 provides merely an example of the many different types of functional arrangements that can be employed to implement the operation of the depicted portions of the management console 116 and smart contract 156. As an alternative, the sequence diagram of FIG. 6 can be viewed as depicting an example of elements of a method implemented within the network environment 100, 200, or 300.

Beginning with block 603, the management console 116 could obtain a device identifier 133 for a client device 106. For example, an administrative user could use the management console 116 to select a client device 106 for further review. The management console 116 could then retrieve the device identifier 133 from the device record 123 for the selected client device 106. As another example, the administrative user could manually provide (e.g., via manual input through the user interface of the client device 106, file upload, to the management console 106, etc.) the device identifier 133 of the client device 106 to be evaluated.

Next, at block 606, the management console 116 could send a request to the smart contract 156 for the state ZKP 163 of the client device 106. For example, the management console 116 could make a function call for a function provided by the smart contract 156. The argument to the function could include the device identifier 133 of the client device 106.

In response, at block 609, the smart contract 156 could search for a state record 157 with a matching device identifier 133. If a matching state record 157 exists, the smart contract 156 could retrieve and return the state ZKP 163 stored in the state record 157.

Subsequently, at block 613, the management console 116 (or any other application) can determine the compliance state of the client device 106 based at least in part on the state ZKP 163. If the current configuration of the client device is compliant with the configuration specified by the management service 113, then the process could end. However, if the state ZKP 163 indicates that the client device 106 is in a non-compliant state, further actions could be taken. These actions could include logging the non-compliance of the client device 106, generating an alert regarding the non-compliance, isolating or quarantining the client device 106 from various network or computer resources, or other remedial actions.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
send a request to a smart contract hosted by a blockchain network for a configuration state for the computing device, the request comprising a device identifier for the computing device;
receive the configuration state from the smart contract; and
apply the configuration state to the computing device.

2. The system of claim 1, wherein the machine-readable instructions further cause the computing device to at least:
generate an attestation that indicates that a current state of the computing device complies with the configuration state specified for the computing device; and
publish the attestation to the blockchain network.

3. The system of claim 2, wherein the machine-readable instructions that cause the computing device to publish the attestation to the blockchain network further cause the computing device to call a function provided by the smart contract with the device identifier and the attestation as parameters for the function.

4. The system of claim 1, wherein the configuration state is a markup language file that specifies an application that should not be installed on the computing device, and the machine-readable instructions that cause the computing device to apply the configuration state further cause the computing device to at least:
determine that the application is installed on the computing device; and
uninstall the application on the computing device.

5. The system of claim 1, wherein the configuration state is a markup language file that specifies an application that should be installed on the computing device, and the machine-readable instructions that cause the computing device to apply the configuration state further cause the computing device to at least:
determine that the application is not installed on the computing device; and
install the application on the computing device.

6. The system of claim 1, wherein the configuration state is a markup language file that specifies a value for a setting for an operating system of the client device or for an application installed on the client device and the machine-readable instructions that cause the computing device to apply the configuration state further cause the computing device to modify the value for the setting.

7. The system of claim 1, wherein the blockchain network is a permissioned blockchain network.

8. A method, comprising:
sending a request to a smart contract hosted by a blockchain network for a configuration state for the computing device, the request comprising a device identifier for the computing device;
receiving the configuration state from the smart contract; and
applying the configuration state to the computing device.

9. The method of claim 8, further comprising:
generating an attestation that indicates that a current state of the computing device complies with the configuration state specified for the computing device; and
publishing the attestation to the blockchain network.

10. The method of claim 9, wherein publishing the attestation to the blockchain network further comprises calling a function provided by the smart contract with the device identifier and the attestation as parameters for the function.

11. The method of claim 8, wherein the configuration state is a markup language file that specifies an application that should not be installed on the computing device, and applying the configuration state further comprises:
determining that the application is installed on the computing device; and
uninstalling the application on the computing device.

12. The method of claim 8, wherein the configuration state is a markup language file that specifies an application that should be installed on the computing device, and applying the configuration state further comprises:
determining that the application is not installed on the computing device; and
installing the application on the computing device.

13. The method of claim 8, wherein the configuration state is a markup language file that specifies a value for a setting for an operating system of the client device or for an application installed on the client device and applying the configuration state further comprises modifying the value for the setting.

14. The method of claim 8, wherein the blockchain network is a permissioned blockchain network.

15. A non-transitory, computer-readable medium, comprising machine-readable instructions that, when executed by a processor of a computing device, cause the computing device to at least:
send a request to a smart contract hosted by a blockchain network for a configuration state for the computing device, the request comprising a device identifier for the computing device;
receive the configuration state from the smart contract; and
apply the configuration state to the computing device.

16. The non-transitory, computer-readable medium of claim 15, wherein the machine-readable instructions further cause the computing device to at least:
generate an attestation that indicates that a current state of the computing device complies with the configuration state specified for the computing device; and
publish the attestation to the blockchain network.

17. The non-transitory, computer-readable medium of claim 16, wherein the machine-readable instructions that cause the computing device to publish the attestation to the blockchain network further cause the computing device to call a function provided by the smart contract with the device identifier and the attestation as parameters for the function.

18. The non-transitory, computer-readable medium of claim 15, wherein the configuration state is a markup language file that specifies an application that should not be installed on the computing device, and the machine-readable instructions that cause the computing device to apply the configuration state further cause the computing device to at least:
determine that the application is installed on the computing device; and
uninstall the application on the computing device.

19. The non-transitory, computer-readable medium of claim 15, wherein the configuration state is a markup language file that specifies an application that should be installed on the computing device, and the machine-readable instructions that cause the computing device to apply the configuration state further cause the computing device to at least:
determine that the application is not installed on the computing device; and
install the application on the computing device.

20. The non-transitory, computer-readable medium of claim 15, wherein the configuration state is a markup language file that specifies a value for a setting for an operating system of the client device or for an application installed on the client device and the machine-readable instructions that cause the computing device to apply the configuration state further cause the computing device to modify the value for the setting.
